(19) United States
(12) Patent Application Publication
(10) Pub. No.: US 2015/0088559 A1
(43) Pub. Date: Mar. 26, 2015

(54) RETIREMENT INCOME ASSURANCE POLICY

(71) Applicant: Pension Advisory Group, Richmond, TX (US)

(72) Inventor: Paul D. Hinson, Sugarland, TX (US)

(73) Assignee: Pension Advisory Group, Richmond, TX (US)

(21) Appl. No.: 14/537,475

(22) Filed: Nov. 10, 2014

Related U.S. Application Data
(63) Continuation-in-part of application No. 14/035,488, filed on Sep. 24, 2013.

(51) Int. Cl. G06Q 40/06; G06Q 20/10

(52) U.S. Cl. CPC G06Q 40/06; G06Q 40/08; G06Q 20/10
USPC 705/4

(57) ABSTRACT

The disclosure relates to certain insurance procedures, methodology and implementation. More specifically, the procedures and methodology relate to insurance or policies which allow for retirement plan contribution when an individual is disabled and is no longer able to receive pay from an employer.

### CROSS REFERENCE TO RELATED APPLICATIONS

This application is a continuation in part of U.S. application Ser. No. 14/035,488 filed on Sep. 24, 2013, the contents of which are incorporated by reference in their entirety.

### FIELD

The disclosure relates to certain methods of transmitting electronic funds on a networked computer system to a trust computer and disbursing the electronic funds from the trust computer. Additionally, the disclosure relates to networked computer systems and apparatuses involved in disbursement of funds. More specifically, the procedures and methodology relate transmitting said electronic funds in furtherance of retirement plan contributions for disabled employees.

### BACKGROUND

There are many different methods of ensuring a person is able to receive retirement benefits by disbursement of these benefits by a bank or a trust. Unfortunately, these methods often rely on the use of mail, and other interactions that can cause errors and prevent a person eligible to receive retirement benefits from accurately doing so. Moreover, employers, such as airlines and other large companies, often have many thousands of workers within retirement plans, but often, the makeup of the workers change and their job types change. For example, the workforce could change over time from a male dominated workforce to a female dominated workforce. The age of the employees could increase due to a switch in hiring experienced employees instead of inexperienced employees. Further, the workforce could change due to layoffs and the like.

It is an unfortunate situation that often an employer cannot contribute to an employee's retirement account if the employee becomes disabled, such as an airline pilot that develops eyesight problems, circulatory problems, and the like. Or alternatively, an airline mechanic who develops back issues and is no longer able to properly service engines.

Due to the many different factors including managing thousands of workers, types of jobs, types of disability and the like, there needs to be an improved system of helping these employees receive retirement benefits even in the event they become disabled. Likewise, there needs to be an improved system for changing disability insurance premiums for the fairness of the employer and a disability insurance company that can contribute to the retirement benefits. Due to an aging population, job changes, layoffs or large numbers of new employees, constant or periodic electronic data transmissions should be sent to an actuarial device or computer to generate a premium based on new changes. To do so by hand or by telephone would be time consuming for large companies and introduce human error. An improved electronic method, system, or apparatus can alleviate these problems.

Likewise, if an individual employee becomes disabled, there is need to correctly transmit this data to an electronic device set up to receive this information and to disburse funds to a device acting as a retirement trust account. The retirement trust account can thereby provide annuitized payments to the employee upon reaching retirement age instead of having a loss of retirement income due to disability. By associating the employee data with electronic funds, the trust is better able to keep track of the many employees that become disabled, regain their ability and reach age of retirement.

Many different retirement plans exist on the market today. However, the defined contribution or 401(k) plan currently is the most popular type of plan for the American worker to save money for retirement.

There are currently over 30 million individual 401(k) plan participants in the United States. These plans have over one trillion dollars in assets, which exceeds the total assets in all other types of plans combined. Approximately 88% of these plans permit the employee, to a limited extent, to choose and/or modify the particular securities in which the employee's money is invested.

Among the advantages of 401(k) plans are that, since the employee does not pay any income tax on the percentage of his/her compensation that is contributed to the plan, such contributions effectively realize an immediate percentage gain defined by the employee's current tax bracket (which amount the employee would otherwise have to pay in income tax if the employee took the compensation in cash). Additionally, neither employer matching contributions nor employer discretionary profit-sharing contributions are subject to taxation when made to the plan. Further, the employee typically is able to choose among a number of different investment securities such as mutual stock funds, bond funds, cash management funds, and the like in which to invest the contributed funds, and normally he/she can move funds from one security to another thereby changing the relative percentage contributed to the different funds of the plan on an ongoing basis.

Still further, should the employee separate from his/her employer, unlike a pension or defined benefit plan, the employee's vested 401(k) funds can be rolled over either to a personal IRA (Individual Retirement Account) or to the 401(k) plan of a new employer.

One problem with current 401(k) plans occurs when an employee becomes disabled, e.g. as a result of injury or illness, and is no longer able to work either permanently or for an extended period of time. During this period of disability, the employee is not receiving regular compensation and therefore cannot continue to make contributions to the retirement plan from periodic paychecks. In fact, even if the disabled employee had available funds from which to make contributions to the retirement plan, such would normally not be permitted as the disabled employee is not an active worker and therefore would not be eligible to make ongoing contributions.

Contributions to a 401(k), 403(b) or 457 plan cannot be made by an employee or an employer unless the employee is currently receiving pay, such as disability compensation from the employer. Typically, the employee must make the election to contribute to the plan from that pay before the pay has been made to and received by the employee.

Under IRC section 415(c)(3)(c) and Regulation sections 1.415-2(e)(3) and 1.415-4(g), compensation to a disabled employee is imputed at pre-disability levels if the employee is actually receiving some pay. Unfortunately, this is a very rare occurrence.

In other words, if an employee becomes disabled, the employee can no longer participate in the qualified retirement plan if the employee is not actively on the payroll of a company. Further, the employee is prohibited from making elective deferrals and the employer is prohibited from making contributions on the behalf of the employee.

According to “Injury Facts” released in 2006 by the National Safety Council, in the United States alone, a fatal injury occurs in the home every 14 minutes. Additionally, a disability injury occurs in the home every four seconds. Like injuries in the home, there is a motor vehicle crash every eleven minutes, and every 13 seconds there is an auto-related disability. Overall, in the home, in automobiles and everywhere else, over 400 Americans become disabled every 10 minutes.

Regarding the severity of disabilities, 43% of people age 40 and above will have a long-term disability event prior to age 65, according the JHA Disability FactBook, 2006 edition. The consequences of long-term disabilities are dire. A 35 year old white collar worker who suffers a disability lasting 90 days or longer will be out of work an average of about six years.

In particular, a computer network system for administering a retirement plan financial product is needed that includes a disability insurance contract that is for the benefit of retirement plan participants. A disability insurance contract insures a participant under a retirement plan against the inability to continue retirement plan contributions due to disability. Premiums due under the insurance contract are paid by the employer. The benefits paid under a disability insurance contract are paid into a separate trust and further allocated to participants′. Further, the benefits paid under the insurance contract are not distributable to the insured participant until the participant is eligible to receive plan distributions as a result of attaining normal retirement age as defined in the retirement plan.

### SUMMARY

Particular embodiments of the disclosure disclosed herein pertain to a computer implemented method for pension supplementation when an employee has a long-term disability. In this embodiment, the computer-implemented method comprises: an employer computer, the employer computer having an interface for sending and retrieving data, wherein the interface is connected by a network.

Further, the method comprises a financial services computer, the financial services computer having an interface for sending and receiving data, wherein the interface is connected to the network and the network is connected to the employer computer; wherein an employer enters data and sends funds through the employer computer to the financial services computer.

Still further, the aforementioned method comprises a bank computer, the bank computer having an interface for sending and receiving data, wherein the interface is connected to the network and the network is connected to the financial services computer; wherein the financial services computer sends funds through the network to the bank computer; and wherein the employer computer sends funds and optionally disabled employee data via the network to the financial services computer upon disablement of the employee, the financial services computer sends the funds via the network to the bank computer, and wherein the bank acts as a trustee for the disabled employee and disperses funds to the disabled employee upon the employee reaching retirement age.

In further embodiments of the disclosure, the method further comprises the financial services company computer sending data through the network to a third party administrator computer having an interface. In such embodiments, the third party administrator computer sends data through the network to the financial services company computer, the data comprising processed insurance claims on an employee benefit program for the employee.

In certain embodiments, the employer computer sends funds to the bank computer in equal, lesser or greater amount to what the employee would have contributed to the retirement plan if employed by the employer. In other embodiments, the employer computer sends funds to the bank computer in equal, lesser or greater amount to what the employer would have contributed to the employee's retirement plan if the employee was under employment by the employer. In other embodiments, the funds are sent from the employer computer to the financial services computer daily, weekly, bimonthly, monthly, biyearly, yearly, or as a single lump sum.

We intend that the term “equal” means an approximation. For example, if a premium amount is generated for 1000 dollars and an employee pays 1100 dollars, and 1000 goes toward the premium amount and another 100 goes towards administrative fees, taxes, surcharges and the like, the transaction will be deemed equal with respect to the premium amount.

In additional embodiments of the disclosure, the bank computer sends data through the network to a third party trustee annuity advisor computer also having an interface. In such embodiments, the third party trustee annuity advisor computer sends data through the network to the bank computer, the data comprising instructions on selecting an annuity provider, selecting an annuity to purchase, instructions on adhering to the terms of the trust, or a combination thereof.

In further embodiments involving the financial services computer, the financial services computer sends data through the network to a cash flow trustee computer operatively connected to the bank computer, the cash flow trustee computer further being operatively connected to an annuities trustee computer. In such embodiments, the third party trustee annuity advisor computer sends data through the network to the annuities trustee computer.

In further embodiments pertaining to the employer computer, the employer computer sends data to the financial services computer comprising the employee's age, retirement benefit contribution plan, type of injury, expectation of duration of disability, employee's gender, employee's health conditions, employee's previous injuries, or a combination thereof.

In further embodiments regarding the financial services computer, the financial services computer sends data regarding the processed insurance claims on the employee benefit program for the employee to an underwriter computer and vice versa.

In still further embodiments regarding the financial services computer, the data sent by the financial services computer to the bank computer comprises monthly disability claim payments for the benefit of the employee, a final lump sum payment for the benefit of the employee, or a combination thereof.

In further methods concerning the bank computer, the bank computer sends, through the network, annuity payments at the employees' retirement to a second bank computer in which the employee has a bank account. Alternatively, the bank computer sends annuity payments at the employees' retirement to a printer operatively connected to the bank, wherein the printer prints out a check for the employee.

Additional embodiments of the disclosure herein pertain to computer implemented methods to improve upon accurately transmitting electronic funds on a networked computer system based on conditional and non-conditional events. The embodiments further pertain to the disbursing of electronic funds after these events.

For instance, in certain embodiments, the method includes initiating a data transfer from a computer comprising a user interface computer over the networked computer system to a financial services computer. Still further, in this method, the data comprises: a number of employees employed by an employer who participate in an employer's retirement benefit contribution plan, age of employees under the plan, a retirement benefit contribution plan, general health condition of employees under the plan, gender of employees under the plan, previous health conditions of employees under the plan, or a combination thereof. Upon receipt of the data, in certain embodiments, the financial services computer sends a premium amount based on the data transmitted by the user interface and a disability insurance contract and sends data comprising the premium amount to the user interface via the networked computer system.

Further, the aforementioned method includes initiating a data transfer from the user interface computer authorizing the transfer of data comprising electronic funds equal to the premium amount to the financial services computer, either from transfer of said electronic funds from a bank computer holding a bank account or by transfer of said electronic funds from a trust computer. In this method, upon a first conditional event, the user interface computer transmits electronic data comprising an employee's injury, type of injury, and expectation of duration of disability or combinations thereof to the financial services computer. Subsequently, the financial services computer transfers data comprising electronic funds from the financial services computer at scheduled time intervals to a trust system computer until a second conditional event occurs or a non-conditional event occurs. We contemplate that the time intervals may be a single interval, such as a single data transfer, or that they may occur every hour, day, week, month, year, decade, and the like. Once the funds are transferred to the trust system computer, the data comprising electronic funds in the trust system is associated with the employee. Further, once the data is in the trust system computer, the funds are used to purchase an annuity or annuities with these funds. Upon a non-conditional event, the data comprising the annuity is disbursed to the employee.

Still further, certain methods comprise transmitting from the user interface computer data comprising the second conditional event to the financial services computer if the second conditional event occurs. Likewise, if the financial services computer receives this data, the financial services computer will cease transmitting data to the trust system computer.

In further methods, the method further comprises an underwriter computer wherein data, such as electronic funds and notification of a first or second conditional event, is sent to the underwriter computer from the financial services computer. In this instance, electronic funds are transmitted across the network to the trust system computer in a manner similar to that without the use of an underwriter. This can include transferring electronic funds at scheduled intervals or ceasing the transfer of electronic funds upon notification of a first and a second conditional event respectively.

In still further embodiments, an actuarial computer is present on the networked computer system which is separate from the financial services computer. In this instance, the user interface computer sends the actuarial computer data comprising the number of employees employed by an employer who participate in an employer's retirement benefit contribution plan, the age of employees under the plan, the retirement benefit contribution plan, the general health condition of the employees under the plan, gender of the employees under the plan, previous health conditions of employees under the plan, or a combination thereof. The actuarial computer is used to generate a premium amount and to transmit this data from the actuarial computer across the network to the financial services computer, which then transmits this data to the user interface computer. Alternatively, the actuarial computer can transmit data comprising the premium amount directly to the user interface computer. Regarding the premium amount, the amount can be adjusted periodically based on new information provided by the user interface such as the number of employees employed by the employer who participate in an employer's retirement benefit contribution plan, the age of employees under the plan, the retirement benefit contribution plan, general health condition of employees under the plan, gender of employees under the plan, previous health conditions of employees under the plan, or a combination thereof. For example, the premium amount can be adjusted weekly, bi-monthly, monthly, bi-annually or annually.

In embodiments of the disclosure pertaining to the first conditional event and the second conditional event, these events are the date that an employee becomes disabled and the date that the employee is able to return to work. The non-conditional event is the date on which the employee, typically by virtue of age, is eligible to receive retirement benefits.

In other embodiments, the trust system computer comprises a cash flow trust computer and receives the data comprising the electronic funds from the financial services computer. The trust system computer further comprises an annuities purchase computer to receive data comprising the electronic funds from the cash flow trust computer. The annuities are purchased with these electronic funds and the annuities are disbursed upon the non-conditional event. In some further instances, the method entails the use of an annuity searching computer which transmits data comprising the type of annuity to be purchased. This can be based on cost of the annuity and rate of return.

Additional embodiments of the disclosure pertain to a networked computer system configured to transfer information and elect funds to a trust computer and configured to disburse annuities from the trust computer based on at least one conditional event and at least one non-conditional event. This networked computer system comprises a series of computers, electronic transmissions and electronic receptions to accomplish this aforementioned task. At the networked computer system's core, are three computers configured to do different tasks: a) a user interface computer on the networked computer system; b) a financial services computer on the networked computer system; and c) a trust system computer on the networked computer system.

As indicated above, the system further comprises a series of electronic transmissions and electronic receptions going between these networked computers. These include: i) a user interface computer initiated electronic data transfer to the financial services computer, the data comprising a number of employees employed by an employer who participate in an employer's retirement benefit contribution plan, age of employees under the plan, a retirement benefit contribution plan, general health condition of employees under the plan, gender of employees under the plan, previous health conditions of employees under the plan, or a combination thereof results in a generation of a premium amount by the financial services computer which is then sent as electronic data over the networked computer system to the user interface computer; and wherein ii) the premium amount sent over the networked computer system to the user interface computer results in a user interface computer initiated transfer of data comprising electronic funds equal to the premium amount to the financial services computer, from either transfer of said electronic funds from a bank computer holding a personal or business bank account, or by transfer of said electronic funds from a trust computer; and further comprising iii) another user interface computer initiated electronic data transfer comprising a notification of a first conditional event to the financial services computer causing a financial services computer initiated data transfer of electronic funds to a trust services computer which then associates the electronic funds received with an account belonging to the employee, and optionally another user interface computer initiated electronic data transfer comprising a notification of a second conditional event to the financial services computer causing the processor to stop data transfer of electronic funds to the trust services computer; and wherein iv) there is a trust services computer initiated purchase of at least one annuity with data comprising electronic funds associated with the employee; and wherein upon a non-conditional event, there is a trust services computer initiated disbursement of the annuity to the employee.

In certain embodiments of the system, such as in the case of step i) the data comprising the number of employees employed by an employer who participate in an employer's retirement benefit contribution plan, age of employees under the plan, a retirement benefit contribution plan, general health condition of employees under the plan, gender of employees under the plan, previous health conditions of employees under the plan, or a combination thereof is transferred to an actuarial computer instead of the financial services computer which results in the generation of the premium. In this case, subsequent to step ii), there is an actuarial computer initiated data transfer comprising the premium amount directly through the networked computer system to the user interface computer, or there is an actuarial computer initiated data transfer comprising the premium amount directly to the financial services computer and a subsequent financial services computer initiated data transfer comprising the premium amount to the user interface computer.

In other embodiments of the system, such as in the case of step iii) there is a financial services computer initiated transfer of electronic funds to an underwriter computer on the networked computer system instead of the trust services computer, and wherein upon receipt of data comprising notification of the first conditional event by the financial services computer, there is a financial services computer initiated transfer of data comprising the notification of the first conditional event to the underwriter computer and an underwriter computer initiated transfer of data comprising electronic funds to the trust services computer. In this instance, if there is a receipt of data comprising notification of the second conditional event by the financial services computer, there is a financial services computer initiated transfer of data comprising the notification of the second conditional event to the underwriter computer and the underwriter computer initiated transfer of data comprising electronic funds to the trust services computer ceases.

In still further embodiments of the system, such as in step iv), prior to the trust services computer initiated purchase of at least one annuity, there is an annuity searching computer initiated transfer of data comprising instructions to the trust services computer to purchase one or more selected annuities with data comprising electronic funds associated with the employee; and wherein the annuity searching computer is on the networked computer system.

Additional embodiments of the disclosure herein pertain to an apparatus for receiving electronic data and disbursing annuitized funds to an entity. In this embodiment, the apparatus configured to: a) receive electronic data comprising a numerical value and electronic funds associated with the entity and storing the data in a computer readable medium; b) receive electronic data from a database of annuity information, the information comprising annuity cost and market performance; c) transmit electronic data comprising electronic funds associated with an entity to a computer selling an annuity; d) receive electronic data comprising electronic funds from a computer selling an annuity and storing the data in a computer readable medium; and e) disburse funds to the entity.

In this aforementioned embodiment, the electronic data comprising a numerical value and electronic funds associated with an entity is received from a device which transmits the data upon a first conditional event and optionally stops the transfer of the data upon a second conditional event.

Still further, the device that transmits the data to the apparatus upon a first conditional and optionally a second conditional event is either: a) a financial services computer configured to receive data comprising the first conditional event and the entity associated with the first conditional event from a user interface computer; or b) an underwriting computer configured to receive data comprising the first conditional event and the entity associated with the first conditional event from the financial services computer.

Likewise, in this embodiment, the user interface computer is configured to send electronic data to the financial services computer, the data comprising a first conditional event of an entity and optionally data comprising a second conditional event of an entity.

Further in this embodiment of the apparatus, the user interface is further configured to send electronic data comprising a number of entities, environmental data of each entity, biological data of each entity to an device configured to run an actuarial model, the device configured to run said actuarial model being further configured to transmit binary data comprising a premium to either: a) the user interface computer, or b) the financial services computer. Still further, if the electronic data comprising the premium is sent to the financial services computer, then the financial services computer is configured to transmit said data to the user interface computer, which is configured to receive said data.

Additionally, in this embodiment of the apparatus, the user interface computer is further configured to send electronic data comprising: a) electronic funds to the financial services computer; or b) an authorization signal to transfer electronic funds to the financial services computer from an electronic account holding electronic funds. In this embodiment, the financial services computer is configured to receive said electronic funds.

Still further in embodiments of the apparatus, the entities are employees. Likewise, the electronic data comprising a number of entities, environmental data of each entity, biological data of each entity is a number of employees employed by an employer who participate in an employer's retirement benefit contribution plan, age of employees under the plan, a retirement benefit contribution plan, general health condition of employees under the plan, gender of employees under the plan, previous health conditions of employees under the plan, or a combination thereof.

Additionally, in these embodiments, the first conditional event is when an employee becomes disabled and is no longer able to work, the second conditional event is when said employee is no longer disabled and returns to work, and the non-conditional event is when the employee is able to receive retirement benefits.

### BRIEF DESCRIPTION OF THE DRAWINGS

FIG. 1 is a flowchart illustrating the methods of the disclosure

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure are able to be embodied in practice.

We mean and intend the following definitions and explanations to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “Covered Individual” means and refers to an individual for which the Employer has paid premiums in order that contributions will be made to a trust for the individual should he/she become disabled.

As used herein, the term “Monthly Income” means and refers to the monthly average of the employee's compensation considered eligible under the Retirement Plan. As of any date, the average is computed for the period after the employee became eligible for the Retirement Plan.

As used herein, the term “Occupation” means and refers to the Occupation of the Covered Individual as stated in the SCHEDULE, for which coverage was rated.

As used herein, the term “Participate” means and refers to that the Covered Individual is physically able to actively engage in the major duties of his or her Occupation as stated in the SCHEDULE.

As used herein, the term “Permanent Total Disablement, Permanently Totally Disabled or Permanent Total Disability” means and refers to the Covered Individual has suffered Total Disablement and that, as a result of the Accidental Bodily Injury or Sickness or Disease directly causing the Total Disablement, a Physician has certified that the Covered Individual is expected to continue to be Totally Disabled from his or her Occupation as stated in the SCHEDULE for the remainder of his or her lifetime.

As used herein, the term “Physician” means and refers to a doctor of medicine or osteopathy who is: 1. licensed to practice medicine and prescribe and administer drugs or perform surgery; and 2. legally qualified as a medical practitioner operating within the scope of his or her license in the state or jurisdiction where services are rendered.

As used herein, the term “employer” means and refers to the person or entity who applied for insurance in respect of the Covered Individual. The employer will pay the required premium. The Policy Holder must have a valid insurable interest or obligation to the Covered Individual as evidenced by an executed contract or other documentation defining such insurable interest.

As used herein, the term “Pre-existing Condition” means and refers to a condition for which: 1. medical advice or treatment was recommended by or received from a Physician during the six (6) month period preceding the Effective Date of this coverage; or 2. symptoms were present during the six (6) month period preceding the Effective Date of this insurance which would cause a prudent person to seek medical attention.

As used herein, the term “Retirement Account” means and refers to an account for Contributions under the Retirement Plan.

As used herein, the term “Retirement Plan” means and refers to the retirement plan of the employer.

According to the present disclosure, a retirement plan financial product includes a long-term disability insurance policy or contract as a component of the underlying plan.

In certain embodiments, the plan has a guaranteed issuance, wherein there is no individual underwriting for insurability. In other embodiments, the occupation of the employee is taken into account and there is individual underwriting for insurability. In certain cases, wherein the occupation is taken into account, greater insurability is for white collar jobs and employees with low risk hobbies or activities. In other cases, wherein occupation is taken into account, there is less insurability for hazardous jobs such as a commercial diver or a commercial fisherman, or wherein the hobbies of the individual include flying a private plane, etc.

In certain embodiments of the disclosure, the owner and beneficiary of the long-term disability insurance policy is the retirement plan trust and not the individual participants or individual or group trusts set up outside the retirement plan.

According to the present disclosure, the premiums are paid by the employer and are tax deductible to the employer.

According to the disclosure, benefits of the retirement package are based on actual contributions (up to qualified plan limits). According to the disclosure, the benefits are deferred until normal retirement age.

In particular, although the disabled recipient would not be classified as an active employee and therefore normally would not be eligible to make elective contributions to the retirement plan, in accordance with the present disclosure the benefits paid under the long-term disability insurance contract are designed to correspond to the elective deferral as well as employer contribution amounts that were being made to the plan by the recipient prior to disability. In this manner, the benefit is somewhat analogous to a “waiver of premium” benefit typically provided as a rider to conventional insurance contracts such as life insurance, wherein premiums due under the insurance contract are automatically paid upon the disability of the insured.

The plan is sold to the employer, so contributions are deductible on the employer's tax return.

Further embodiments of the disclosure concern the computer program for operating the insurance policy.

In certain further embodiments of the disclosure, the disability insurance premiums are reported as income to the recipients; therefore, benefits are tax-free to participants at retirement up to their policy basis.

Certain embodiments concern the improved method of fund disbursement as discussed above. In these embodiments, the methods rely on electronic apparatuses which are configured to specialized tasks. For example, a user interface computer can keep track of the hundreds or thousands of employees associated with a company. Further, the user interface computer can receive information from a computer which is set up to coordinate payments, receive data on premiums from an actuarial computer and disburse funds to a trust computer.

In further embodiments concerning the user interface computer, upon entering data regarding employee information, type of disability retirement contract selected, and the like, the data can be transmitted directly to a device configured to run an actuarial model and generate a premium. This premium can be transmitted in electronic form directly to the user interface computer or the computer set up to coordinate payments, receive data on premiums from the actuarial device, and disburse funds to the trust device. For purposes of simplicity, this device can be called a financial services computer as it is specifically configured for this purpose.

In still further embodiments concerning the user interface computer, the user interface computer can transmit electronic funds corresponding to the premium from an account associated with the user interface computer, or a trust account associated with the user interface computer. To eliminate error, such accounts have funds stored in electronic form. These funds are transferred to the financial services computer. While it is contemplated that the amount transferred from the user interface computer to the financial services computer is equal to the amount of the premium, it is to be understood that “equal to” is sometimes imprecise and will include administrative fees and the like. However, the premium amount equal to that generated by the actuarial device is always paid from the aforementioned electronic funds.

In embodiments regarding the actuarial device, the actuarial device receives the employee information for the numerous employees, such as airline pilots and the like, either directly from the user interface or indirectly from the financial services computer. The actuarial device will be configured to receive this information as well as the group disability contract information in order to generate the premium and send the electronic data comprising the premium directly to the user interface or indirectly through the financial services computer.

Regarding the financial services computer, the computer, as mentioned before, is specifically configured for the aforementioned services. Moreover, as indicated above, the financial services computer receives a signal from the user interface computer of a conditional event wherein the employee becomes disabled and is no longer able to work for the company. In this instance, the financial services computer will transmit electronic funds according to the group disability contract to a trust device specifically configured to receive the funds.

Alternatively, the financial services computer can notify an underwriter computer of the first conditional event, wherein the underwriter computer will transmit electronic funds according to the group disability contract to the trust device.

Typically, the financial services computer or the underwriter computer, which is specifically configured to transfer the electronic funds to the trust device, transfers the electronic funds at periodic intervals. The intervals can be daily, weekly, bi monthly, monthly, quarterly, biannually, annually, and the like. This is typically done so that in the case of a second conditional event, no more electronic funds are transferred to the trust device.

Regarding the second conditional event, the second conditional event is the date when the employee is no longer disabled and can return to work for the company. In this case, the delivery of the information to the financial services computer and/or to the underwriter computer is the same as the notification of the first conditional event.

Regarding the trust device, the trust device receives the funds from the financial services computer or the underwriter computer. The trust device is an electronic apparatus, computer or other similar device specifically configured to associate the funds with the disabled employee and to disburse the funds when the employee is able to receive the funds due to retirement age or the age at which the employee is able to receive retirement benefits.

Further regarding the trust device, the trust device is configured to receive electronic data or other forms of data regarding the purchase of an annuity or annuities with the electronic funds associated with the disabled employee's account. The trust device can then transmit funds to a device that has annuities and purchase said annuities for the benefit of the employee.

Once the employee has reached retirement age or has reached the age wherein the employee is able to receive retirement benefits, which can be considered a non-conditional event, the trust device will electronically transfer the funds to an electronic bank account of the employee. Alternatively, the trust device can transmit the data to a printer to print out checks for the benefit of the employee.

Certain further embodiments of the disclosure concern the computer program by which the methods herein are executed.

In certain embodiments, the program has computer readable and computer executable media that itself contains a plurality of computer programs, algorithms, software applications, including operations and procedures of the insurance method encoded as computer readable and computer executable program code in the form of a program product. Still further, the program can have algorithms, software applications, including operations and procedures of the insurance method involving payment methods of a premium and any financing options generated by the program. In practice, the user would enter into the program from a computer. The employer would be able to contribute to the plan by using a credit card number and other necessary information needed for payment. Alternatively, the computer program allows for future payment by financing, cash, check, or other valuable items to be delivered to an insurance agent or insurance company controlling the program.

In certain embodiments, the insurance method can be implemented in software, firmware or hardware, or a combination of each. In certain embodiments, the insurance method is implemented in software as an executable program code which comprises an ordered listing of executable instructions for implementing logical functions and which is executed by a server.

In certain embodiments, the insurance method is implemented in computer or other electronic device having a processor or multiple processors. The processor is a hardware device for executing software including software stored in the memory and in the program unit, including a program encoded as the reimbursement insurance method. The processor can be any custom made or commercially available, off-the-shelf processor, a central processing unit (CPU), one or more auxiliary processors, a semiconductor-based microprocessor, in the form of a microchip or chip set, a macroprocesssor, or generally any device for executing software instructions. The memory and the dynamic repository and the storage device or devices, and the plurality of databases can include any one of or a combination of volatile memory elements, including random access memory (including RAM, DRAM, SRAM and/or SDRAM) and non-volatile memory elements including read only memory (including ROM, erasable programmable read only memory, electronically erasable programmable read only memory EEPROM, programmable read only memory PROM, and/or compact disc read only memory CD-ROM or FLASH memory) magnetic tape, disk, diskette, cartridge, cassette and/or optical memory. The memory can have an architecture where various components are situated remotely from one another, but can be accessed by the processor.

Operation

In operation, in certain embodiments of the disclosure, the method disclosed herein defers paying disability benefits until retirement. In certain further embodiments, after satisfying an elimination period, benefits are paid by an underwriter, such as Lloyd's, into an annuity with the annuity held in trust. In certain further embodiments, after five years of disability status, the underwriter, such as Lloyd's, will pay a lump sum into the annuity. At retirement, a stream of income is payable directly by the annuity carrier to the participant to supplement his retirement income.

Further in operation, in certain embodiments, when calculating a covered individual's monthly benefit, the contribution for any month before the effective date of the group master policy will be the recipient's total contributions in the 12 months before the effective date of the group master policy divided by 12. If no contributions have been credited to the recipient's Retirement Account in the previous 12 months, then the monthly benefit is zero. While this embodiment contemplates monthly benefits, we contemplate that the benefits can be daily, weekly, bimonthly, every six months and so on in certain applications.

Still further in operation, in certain further embodiments, if the covered individual becomes disabled, the recipient's monthly benefit during the first year of disability remains the same as it was on the day he/she become disabled. While the recipient's disability continues, the recipient's monthly benefit will increase on each anniversary of the date the disability began. In certain embodiments, it will be 3% more than it was one year earlier, for example. If his/her disability ends and he/she returns to the eligible class, his/her monthly benefit will be calculated as defined.

Further in operation, premiums are paid by the employer. Premiums are tax deductible for the employer. The assets are held in a bank trust department. Benefits are based on actual contributions. Benefits are deferred until normal retirement age. There is no individual underwriting insurability.

In one embodiment, the benefit elimination period is 6 months. In another embodiment, the benefit elimination period is 12 months.

In one embodiment, the product is renewable. In another embodiment, there is a three year lock on rates.

In yet another embodiment, there is a cost-of-living adjustment. In an embodiment, the cost-of-living adjustment is 3%. In another embodiment, claims made in the first 12 months are equal to 3% of the recipient's current salary.

In certain further embodiments of the disclosure, the method is applied for the benefit of commercial pilots, such as airline pilots and air-cargo pilots. In embodiments regarding commercial pilots, a long-term disability, in addition to the foregoing, is a loss of first class medical.

Regarding a first class disability that will prohibit a pilot from operating a commercial aircraft, an examiner conducts a health assessment of a pilot. In general, unless otherwise directed by the FAA, a health examiner must deny the applicant if the applicant has a history of any of the following: 1) diabetes mellitus requiring hypoglycemic medication; 2) angina pectoris; 3) coronary heart disease that has been treated or, if untreated, that has been symptomatic or clinically significant; 4) myocardial infarction; 5) cardiac valve replacement; 6) permanent cardiac pacemaker; 7) heart replacement; 8) psychosis; 9) bipolar disorder; 10) personality disorder that is severe enough to have repeatedly manifested itself by overt acts; 11) substance dependence; 12) substance abuse: 13) epilepsy; 14) disturbance of consciousness and without satisfactory explanation of cause; and 15) transient loss of control of nervous system function(s) without satisfactory explanation of cause.

Further, for a pilot to pass a first class medical examination in order to maintain the ability to fly a commercial aircraft, the examiner must conduct vision and hearing tests. In the visual test, distant vision, intermediate vision, and near vision are assessed. Distant vision must demonstrate 20/20 or better in each eye with or without correction. Intermediate vision must be 20/40 or better in each eye separately, with or without correction, as measured at 32 inches. Near vision must be 20/40 or better in each eye separately, with or without correction, as measured at 16 inches.

Likewise, a pilot must have proper hearing. The hearing must demonstrate that the pilot can hear an average conversational voice in a quiet room, using both ears at 6 feet, with the back turned to the examiner or by passing an audiometric test. In cases where the audiometric is used, at least one ear must hear at 500, 1000, 2000 and 3000 Hz sounds of a minimum of 35, 30, 30 and 40 Db respectively. The other ear must hear sounds of a minimum of 35, 50, 50 and 60 Db respectively.

### Examples

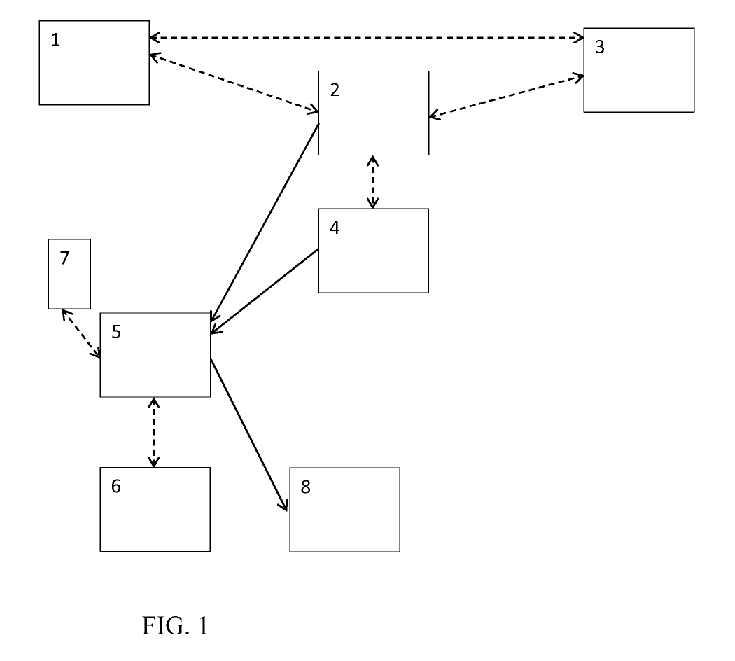

As seen in FIG. 1, an employer 10 pays a premium to financial services company 20 which collects the bills 30 and underwrites the policy 40. Next, the monthly disability claim payments are sent to a trust 50 managed by a bank 60 with an annuities trust 65. The trust then pays an annuity to the disabled employee 75 upon retirement such that the retired employee remains whole as if the employer had contributed to the 401(k) or other retirement package while the employee was off the payroll.

In further aspects pertaining to FIG. 1, to oversee the collection aspect of the financial services company 20, a third party administrator 70 processes the insured claims for the employee benefit program as a separate entity, thus transferring the data between the financial services company 20 which acts as the collection agent, and the third party administer 70 which processes the claims.

In still further aspects pertaining to FIG. 1, a third party trustee annuity advisor 80 oversees the annuity trust 65, and is responsible for adhering to the terms of the trust in the trust document. More specifically, the trustee annuity advisor holds legal title. Further, the trustee annuity advisor 80 selects the annuity provider and selects the annuity to purchase. Upon reaching retirement, the annuity is paid to the disabled recipient 90.

Tables 1-3 provide examples if an employee becomes disabled under the plan. The schedule X table is an actuarial table.

TABLE 1

| | |
|---|---|
| Male, age 50 | 200k salary, Contribution Max 401(k), Max |
| | Catch Up Provision, 100% Employer Match |
| | Contribution |

| | | |
|---|---|---|
| Current Salary/70% LTD Plan | Actively | On |
| | At work | disability |
| Current Salary/70% LTD Plan | 200,000 | 140,000 |
| Annual 401(k) Elective Deferral | 23,000 | 0 |
| Taxable Income | 177,000 | 140,000 |
| Tax from Schedule X-Single Table | 43,020 (24.3%) | 32,660 (23.3%) |
| Disposable Income | 133,980 | 107,340 |
| Annual Employer Contribution | 23,000 | |
| Total Annual Retirement | 46,000 | |
| Contribution | | |

Risk for Employee Participant: If disabled, missed contributions
reduce the expected Accumulated Value in 401(k) at age 65
(assuming 5.0% net investment yield).

| | |
|---|---|
| Disabled at start of year 4, on disability for 1 year: | 78,676 |
| Disabled at start of year 4, on disability for 3 year: | 289,692 |
| Disabled at start of year 4, on disability for 5 year: | 478,009 |
| Disabled at start of year 4, on disability through | 709,188 |
| age 65: | |

TABLE 2

| | |
|---|---|
| Female, age 40 | 160k salary, Max 401(k), 100% Employer |
| | Match Contribution |

| | | |
|---|---|---|
| Current Salary/70% LTD Plan | Actively | On |
| | At work | disability |
| Current Salary/70% LTD Plan | 160,000 | 112,000 |
| Annual 401(k) Elective Deferral | 17,500 | 0 |
| Taxable Income | 142,500 | 112,000 |
| Tax from Schedule X-Single Table | 33,360 (23.4%) | 24,820 (23.3%) |
| Disposable Income | 109,140 | 87,180 |
| Annual Employer Contribution | 17,500 | |
| Total Annual Retirement | 35,000 | |
| Contribution | | |

Risk for Employee Participant: If disabled, missed contributions
reduce the expected Accumulated Value in 401(k) at age 65
(assuming 5.0% net investment yield).

| | |
|---|---|
| Disabled at start of year 4, on disability for 1 year: | 62,855 |
| Disabled at start of year 4, on disability for 3 year: | 179,728 |
| Disabled at start of year 4, on disability for 5 year: | 285,736 |
| Disabled at start of year 4, on disability through | 602,454 |
| age 65: | |

TABLE 3

| | |
|---|---|
| Male, age 40 | 100k salary, Max 401(k), 8% Employer |
| | Contribution Profit Sharing Plan |

| | | |
|---|---|---|
| Current Salary/60% LTD Plan | Actively | On |
| | At work | disability |
| Current Salary/60% LTD Plan | 100,000 | 60,000 |
| Annual 401(k) Elective Deferral | 16,000 | 0 |
| Taxable Income | 84,000 | 60,000 |
| Tax from Schedule X-Single Table | 17,030 (20.3%) | 11,030 (18.4%) |
| Disposable Income | 66,790 | 48,970 |
| Annual Employer Contribution | 8,000 | |
| Total Annual Retirement | 24,000 | |
| Contribution | | |

Risk for Employee Participant: If disabled, missed contributions
reduce the expected Accumulated Value in 401(k) at age 65
(assuming 5.0% net investment yield).

| | |
|---|---|
| Disabled at start of year 4, on disability for 1 year: | 60,647 |
| Disabled at start of year 4, on disability for 3 year: | 173,414 |
| Disabled at start of year 4, on disability for 5 year: | 275,697 |
| Disabled at start of year 4, on disability through | 781,583 |
| age 65: | |

From the foregoing description, one of ordinary skill in the art can easily ascertain the essential characteristics of this disclosure, and without departing from the spirit and scope thereof, can make various changes and modifications to adapt the disclosure to various usages and conditions. For example, we do not mean for references such as above, below, left, right, and the like to be limiting but rather as a guide for orientation of the referenced element to another element. A person of skill in the art should understand that certain of the above-described structures, functions, and operations of the above-described embodiments are not necessary to practice the present disclosure and are included in the description simply for completeness of an exemplary embodiment or embodiments. In addition, a person of skill in the art should understand that specific structures, functions, and operations set forth in the above-described referenced patents and publications can be practiced in conjunction with the present disclosure, but they are not essential to its practice.

The disclosure can be embodied in other specific forms without departing from its spirit or essential characteristics. A person of skill in the art should consider the described embodiments in all respects only as illustrative and not restrictive. The scope of the disclosure is, therefore, indicated by the appended claims rather than by the foregoing description. A person of skill in the art should embrace, within their scope, all changes to the claims which come within the meaning and range of equivalency of the claims. Further, we hereby incorporate by reference, as if presented in their entirety, all published documents, patents, and applications mentioned herein.

1. A computer implemented method of transmitting electronic funds on a networked computer system based on conditional and non-conditional events, and disbursing the electronic funds, the method comprising:
A) initiating a data transfer from a computer comprising a user interface computer over the networked computer system to a financial services computer, the data comprising: a number of employees employed by an employer who participate in an employer's retirement benefit contribution plan, age of employees under the plan, a retirement benefit contribution plan, general health condition of employees under the plan, gender of employees under the plan, previous health conditions of employees under the plan or a combination thereof; wherein upon receipt of the data, the financial services computer sends a premium amount based on the data transmitted by the user interface and a disability insurance contract and sends data comprising the premium amount to the user interface via the networked computer system; and
B) initiating a data transfer from the user interface computer authorizing the transfer of data comprising electronic funds equal to the premium amount to the financial services computer, either from transfer of said electronic funds from a bank computer holding a bank account or by transfer of said electronic funds from a trust computer; and
C) wherein upon a first conditional event, the user interface computer transmits electronic data comprising an employee's injury, type of injury, and expectation of duration of disability or combinations thereof to the financial services computer; and
D) transferring data comprising electronic funds from the financial services computer at scheduled time intervals to a trust system computer until a second conditional event occurs or a non-conditional event occurs;
E) associating the data comprising electronic funds in the trust system computer with the employee;
F) purchasing at least one annuity with data comprising electronic funds associated with the employee; and wherein
G) data comprising the annuity is disbursed from the trust system computer to the employee upon the non-conditional event.

2. The method of claim 1, further comprising transmitting from the user interface computer data comprising the second conditional event to the financial services computer if the second conditional event occurs.

3. The method of claim 2, further comprising having the financial services computer cease transmitting data to the trust system computer upon the financial services computer receiving data that the second conditional event has occurred.

4. The method of claim 1, further comprising sending data from the financial services computer comprising electronic funds to an underwriter computer and data comprising the first conditional event to the underwriter computer, and further comprising sending data comprising electronic funds from the underwriter computer at scheduled time intervals to the trust system computer until the second conditional event occurs or a non-conditional event occurs in lieu of step D.

5. The method of claim 1, further comprising an actuarial computer separate from the financial services computer, and further comprising sending from the user interface computer to actuarial computer electronic data from the user interface computer comprising the number of employees employed by an employer who participate in an employer's retirement benefit contribution plan, the age of employees under the plan, the retirement benefit contribution plan, the general health condition of the employees under the plan, gender of the employees under the plan, previous health conditions of employees under the plan or a combination thereof and generating a premium amount using the actuarial computer and then transmitting the premium amount from the actuarial computer to the financial services computer, and then transmitting from the financial services computer to the user interface computer.

6. The method of claim 1, wherein the non-conditional event is a date at which the employee is eligible to receive retirement benefits.

7. The method of claim 1, wherein the premium amount is adjusted weekly, bi-monthly, monthly, bi-annually or annually based on the data sent by the user interface computer to the financial services computer comprising the number of employees employed by the employer who participate in an employer's retirement benefit contribution plan, the age of employees under the plan, the retirement benefit contribution plan, general health condition of employees under the plan, gender of employees under the plan, previous health conditions of employees under the plan or a combination thereof.

8. The method of claim 7, further comprising sending data from the user interface, the data comprising the number of employees employed by the employer who participate in an employer's retirement benefit contribution plan, the age of employees under the plan, the retirement benefit contribution plan, general health condition of employees under the plan, gender of employees under the plan, previous health conditions of employees under the plan or a combination thereof directly to an actuarial computer, or through the financial services computer, and wherein the actuarial computer generates a premium and transfers data comprising the premium directly to the user interface or to the financial services computer, which sends the data comprising the premium to the user interface, and wherein the financial services computer does not generate the premium.

9. The method of claim 1, wherein the trust system computer comprises a cash flow trust computer to receive the data comprising electronic funds from the financial services computer and an annuities purchase computer to receive data comprising the electronic funds from the cash flow trust computer, purchase annuities with the funds and disburse the annuities upon the non-conditional event.

10. The method of claim 1, further comprising an annuity searching computer which transmits data comprising cost of annuity and rate of return to the annuities purchase computer.

11. A networked computer system configured to transfer information and elect funds to a trust computer and configured to disburse annuities from the trust computer based on at least one conditional event and at least one non-conditional event, the system comprising:
A) a user interface computer on the networked computer system;
B) a financial services computer on the networked computer system;
C) a trust system computer on the networked computer system; and wherein
i) a user interface computer initiated electronic data transfer to the financial services computer, the data comprising a number of employees employed by an employer who participate in an employer's retirement benefit contribution plan, age of employees under the plan, a retirement benefit contribution plan, general health condition of employees under the plan, gender of employees under the plan, previous health conditions of employees under the plan or a combination thereof results in a generation of a premium amount by the financial services computer which is then sent as electronic data over the networked computer system to the user interface computer; and wherein
ii) the premium amount sent over the networked computer system to the user interface computer results in a user interface computer initiated transfer of data comprising electronic funds equal to the premium amount to the financial services computer, from either transfer of said electronic funds from a bank computer holding a personal or business bank account, or by transfer of said electronic funds from a trust computer and further comprising
iii) another user interface computer initiated electronic data transfer comprising a notification of a first conditional event to the financial services computer causing a financial services computer initiated data transfer of electronic funds to a trust services computer which then associates the electronic funds received with an account belonging to the employee, and optionally another user interface computer initiated electronic data transfer comprising a notification of a second conditional event to the financial services computer causing the processor to stop data transfer of electronic funds to the trust services computer; and wherein
iv) there is a trust services computer initiated purchase of at least one annuity with data comprising electronic funds associated with the employee; and wherein upon a non-conditional event, there is a trust services computer initiated disbursement of the annuity to the employee.

12. The system of claim 11, wherein in step i), wherein the data comprising the number of employees employed by an employer who participate in an employer's retirement benefit contribution plan, age of employees under the plan, a retirement benefit contribution plan, general health condition of employees under the plan, gender of employees under the plan, previous health conditions of employees under the plan or a combination thereof is transferred to an actuarial computer instead of the financial services computer which results in the generation of the premium, and wherein, subsequent to step ii),
A) there is an actuarial computer initiated data transfer comprising the premium amount directly through the networked computer system to the user interface computer, or
B) there is an actuarial computer initiated data transfer comprising the premium amount directly to the financial services computer and a subsequent financial services computer initiated data transfer comprising the premium amount to the user interface computer.

13. The system of claim 11, wherein in step iii), there is a financial services computer initiated transfer of electronic funds to an underwriter computer on the networked computer system instead of the trust services computer, and wherein upon receipt of data comprising notification of the first conditional event by the financial services computer, there is
A) a financial services computer initiated transfer of data comprising the notification of the first conditional event to the underwriter computer and an underwriter computer initiated transfer of data comprising electronic funds to the trust services computer;
and wherein, if there is a receipt of data comprising notification of the second conditional event by the financial services computer, there is
B) a financial services computer initiated transfer of data comprising the notification of the second conditional event to the underwriter computer and the underwriter computer initiated transfer of data comprising electronic funds to the trust services computer ceases.

14. The system of claim 11, wherein in step iv) prior to the trust services computer initiated purchase of at least one annuity, there is an annuity searching computer initiated transfer of data comprising instructions to the trust services computer to purchase one or more selected annuities with data comprising electronic funds associated with the employee; and wherein the annuity searching computer is on the networked computer system.

15. The system of claim 11, wherein:
A) the first conditional event is a date on which the employee becomes disabled;
B) the second conditional event is a date on which the employee is no longer disabled; and
C) the non-conditional event is a date on which the employee is able to receive retirement benefits.

16. The system of claim 11, wherein the premium amount is adjusted weekly, bi-monthly, monthly, bi-annually or annually based on reception of data sent to the financial services computer or an actuarial computer by the user interface computer initiated electronic data transfer comprising the number of employees employed by an employer who participate in an employer's retirement benefit contribution plan, age of employees under the plan, a retirement benefit contribution plan, general health condition of employees under the plan, gender of employees under the plan, previous health conditions of employees under the plan or a combination thereof.

17. An apparatus for receiving electronic data and disbursing annuitized funds to an entity, the apparatus configured to:
A) receive electronic data comprising a numerical value and electronic funds associated with the entity and storing the data in a computer readable medium;
B) receive electronic data from a database of annuity information, the information comprising annuity cost and market performance;
C) transmit electronic data comprising electronic funds associated with an entity to a computer selling an annuity;
D) receive electronic data comprising electronic funds from a computer selling an annuity and storing the data in a computer readable medium; and
E) disburse funds to the entity, and
wherein the electronic data comprising a numerical value and electronic funds associated with an entity is received from a device which transmits the data upon a first conditional event and optionally stops the transfer of the data upon a second conditional event, and wherein
the device that transmits the data to the apparatus upon a first conditional and optionally a second conditional event is either:
i. a financial services computer configured to receive data comprising the first conditional event and the entity associated with the first conditional event from a user interface computer; or
ii. an underwriting computer configured to receive data comprising the first conditional event and the entity associated with the first conditional event from the financial services computer and wherein
the user interface computer is configured to send electronic data to the financial services computer, the data comprising a first conditional event of an entity and optionally data comprising a second conditional event of an entity; and
the user interface is further configured to send electronic data comprising a number of entities, environmental data of each entity, biological data of each entity to an device configured to run an actuarial model, the device configured to run said actuarial model being further configured to transmit binary data comprising a premium to either:
i. the user interface computer or
ii. the financial services computer, and wherein if the electronic data comprising the premium is sent to the financial services computer, then the financial services computer is configured to transmit said data to the user interface computer, which is configured to receive said data; and
wherein the user interface computer is further configured to send electronic data comprising:
i. electronic funds to the financial services computer; or
ii. an authorization signal to transfer electronic funds to the financial services computer from an electronic account holding electronic funds; and
wherein the financial services computer is configured to receive said electronic funds.

18. The method of claim 17, wherein the entities are employees.

19. The method of claim 18, wherein the electronic data comprising a number of entities, environmental data of each entity, biological data of each entity is a number of employees employed by an employer who participate in an employer's retirement benefit contribution plan, age of employees under the plan, a retirement benefit contribution plan, general health condition of employees under the plan, gender of employees under the plan, previous health conditions of employees under the plan or a combination thereof.

20. The method of claim 19, wherein the first conditional event is when an employee becomes disabled and is no longer able to work, the second conditional event is when said employee is no longer disabled and returns to work, and the non-conditional event is when the employee is able to receive retirement benefits.
